(19) United States
(12) Patent Application Publication
(10) Pub. No.: US 2003/0224918 A1
(43) Pub. Date: Dec. 4, 2003

(54) Method and apparatus for making cigarette filters with a centrally located flavored element

(75) Inventors: Robert C. Lanier JR., Moseley, VA (US); Steven M. Campbell, Mechanicsville, VA (US); Stephen J. Bellamah, Midlothian, VA (US)

Correspondence Address: BURNS DOANE SWECKER & MATHIS L L P, POST OFFICE BOX 1404, ALEXANDRIA, VA, 22313-1404, US

(73) Assignee: Philip Morris USA Inc., New York, NY

(21) Appl. No.: 10/397,275

(22) Filed: Mar. 27, 2003

Related U.S. Application Data
(60) Provisional application No. 60/368,376, filed on Mar. 29, 2002.

(51) Int. Cl. B31C 13/00

(52) U.S. Cl. 493/39; 493/49; 131/88

(57) ABSTRACT

A filter making apparatus includes a positioning device having a passageway therethrough, with the passageway guiding a continuous flavor element such as a continuous strand of textile material from an inlet of the passageway to an outlet of the passageway. A liquid flavorant is introduced into the passageway at a desired flow rate and the strand of material carries the supplied liquid flavorant out of the positioning device at a rate substantially equal to the desired flow rate. A portion of the passageway can form a bath of the liquid flavorant supplied to the passageway through a separate inlet at approximately atmospheric pressure. A portion of the positioning device guides the continuous strand of material through the bath, or guides the strand to pass along the bottom of the passageway, and the saturated or partially saturated strand of material then exits from an outlet of the passageway to a point in the path of filter tow material that is being converged to form a filter rod.

### FIELD OF THE INVENTION

This invention relates to methods and apparatus for making cigarette filters that incorporate a centrally located flavored element which affects the taste of smoke drawn through the filter.

### BACKGROUND OF THE INVENTION

Tobacco smoke filters have been produced that incorporate a flavor agent where the agent is applied uniformly over the filtering material before the filtering material is gathered and shaped to form the filter product. An example of these conventional filters includes a flavored tobacco smoke filter made from bonded cellulose acetate filamentary tow in which a liquid plasticizer such as triacetin is sprayed uniformly over the tow before it is gathered to its final rod form. The flavoring agent is normally dissolved in the liquid plasticizer, and the plasticizer effects the bonding between adjacent filaments.

Other methods of producing cigarette filters are disclosed in U.S. Pat. Nos. 4,549,875, 4,768,526 and 4,281,671.

It has been found in practicing the conventional methods for producing tobacco smoke filters that problems result when the use of a particular flavoring agent is to be terminated or when one flavoring agent is to be substituted for another. These problems result because the spray booth within which the plasticizer is applied will be contaminated with the first flavoring agent employed, so that the subsequently produced filters would be contaminated unless production was stopped and the contaminated booth was cleaned or replaced.

Known methods for introducing a flavored element into the interior of a filter have also suffered from the disadvantage that flavorant is often not introduced in the proper amounts or at the proper location within the cigarette filter to achieve the desired effect on the smoke passing through the filter, and the position of the flavored element within the smoke filter could not be precisely controlled.

### SUMMARY OF THE INVENTION

In view of the disadvantages of prior art systems for producing filters, and in particular tobacco smoke filters, a method of continuously producing tobacco smoke filter rod according to the invention includes advancing a supply of filter tow material, converging the advancing filter tow material to a rod form, passing a flavor element, such as a continuous line of textile material, through a positioning device for entraining the flavor element with the advancing filter tow material at a point during the converging of the filter tow material to a rod form, and supplying a liquid flavorant at approximately atmospheric pressure to the positioning device to partially fill the positioning device. In one embodiment, a bath of the liquid flavorant is formed within a passageway in the positioning device and the flavor element is passed through the bath of flavorant before being entrained in the advancing filter tow material. The continuous flavor element is preferably at least one yarn or other material having the quality of absorbing the maximum amount of liquid flavorant and carrying the flavorant with the flavor element to be positioned centrally within the completed filter rod.

The positioning device can be configured and positioned relative to equipment designed for converging filter tow into a filter rod such that a first portion of the positioning device forms a bath of the liquid flavorant while a second portion of the positioning device directs the continuous textile material into the bath before the textile material exits from the outlet of the positioning device.

The positioning device is preferably provided with at least first and second inlets, with the continuous flavor element passing through the first inlet and the liquid flavorant being supplied through the second inlet. In a preferred embodiment, the positioning device is configured with a bend or “goose-neck” near the first inlet such that the continuous flavor element, in passing through the goose-neck, is maintained at the bottom of the positioning device for the rest of the way to the exit. This ensures that the flavor element will remain in the liquid flavorant that collects in the bottom of the positioning device, or is provided at an intermediate point along the passageway through the device.

The liquid flavorant is preferably supplied at a desired rate into the positioning device through the second inlet, which can be positioned at an end of the device or at some intermediate, downstream point, using a metering pump while the continuous flavor element is introduced into the positioning device through the first inlet. The liquid flavorant is partially absorbed by the textile material and/or adheres to the textile material by surface tension such that the textile material and the flavorant travel through the positioning device toward the outlet of the passageway through the positioning device, which is positioned in the path of the filter tow material at a point downstream of at least a portion of a converging device that funnels the filter tow material into a rod form. Preferably, the flavor element is at least partially saturated by the liquid flavorant as it passes through the bath, or as the flavor element travels along the bottom of the passageway downstream from the inlet for liquid flavorant.

In the case of traditional filter making equipment, the outlet of the positioning device can be positioned under the tongue, which is positioned downstream of a transport jet and an air funnel that form part of the converging device. The tongue guides the filter tow material in the final stage before it is converged to a rod form, and the positioning device guides the liquid flavorant and the continuous flavor element to a position relative to the tongue that ensures desired positioning of the continuous length of textile material in the finished filter rod.

The positioning device is preferably tilted upward towards its outlet end when it is assembled with the filter making equipment. The inlet for introduction of liquid flavorant can be positioned along the device at a point downstream from where the flavor element is introduced, or at the same end of the device through a separate inlet. An upstream portion of the positioning device can be configured to form a bath of the liquid flavorant at an intermediate low point of the positioning device. In the embodiment of the device where a bath of flavorant is formed in the device, the continuous flavor element enters the positioning device through an inlet and is preferably guided through the bath of liquid flavorant by a guide portion of the positioning device before exiting from the outlet of the positioning device. The filter tow material that is converging around the outlet of the positioning device underneath the tongue of the filter making equipment pulls the continuous flavor element along with the filter tow material as the tow material continues to move in a downstream direction to be formed into the finished filter rod. The continuous flavor element carries the liquid flavorant as it exits from the outlet of the positioning device.

The rate of movement of the flavor element through the passageway can be synchronized with the rate at which liquid flavorant is introduced into the passageway such that the flavor element can carry all of the liquid flavorant introduced into the device as it passes through the flavorant collecting in the bottom of the device. In an alternative embodiment, a portion of the positioning device can be configured to collect liquid flavorant into a bath through which the flavor element is passed. Preferably, an equilibrium point is reached at which the amount of liquid flavorant being carried by the flavor element is the same amount as is metered into the positioning device. This equilibrium point is maintained and the passageway through the positioning device remains at atmospheric pressure. The metering pump providing liquid flavorant through an inlet of the positioning device is preferably controlled such that the amount of liquid flavorant introduced into the device, or introduced and collected in a bath at the low point of the positioning device, remains substantially the same as the continuous flavor element pulls the liquid flavorant along with it when exiting from the outlet of the positioning device.

The positioning device can be provided with fine-tune adjustments so that its final position relative to the converging filter tow material under the tongue of the filter making equipment can be precisely controlled. It is preferred to locate the continuous flavor element carrying liquid flavorant in the center of the path of maximum air flow through the finished cigarette filter rods. The outlet of the positioning device is preferably provided with a sufficient diameter to allow for passage of the continuous flavor element, such as continuous length of textile material carrying liquid flavorant without creating any undesirable back pressure in the positioning device and yet with the outlet of the positioning device being maintained at a small enough outer diameter such that it does not protrude too far into the path of converging filter tow material at the point where the filter tow material is being shaped by the tongue into the final rod form.

### BRIEF DESCRIPTION OF THE DRAWINGS

The invention is illustrated by way of example only with reference to the accompanying drawings, in which:

FIG. 1A is a side elevation view of a portion of an apparatus for forming filters including a positioning device according to a first embodiment of the present invention.

FIG. 1B is an end view of the apparatus shown in FIG. 1A, taken from the inlet end of the apparatus.

FIG. 1C is an end view of the apparatus shown in FIG. 1A, taken from the outlet end of the apparatus.

FIG. 2 is a partial sectional view of the positioning device shown in FIG. 1A, showing a bath of liquid flavorant formed in the passageway through the positioning device.

FIGS. 3A and 3B illustrate details of a bracket with horizontal and vertical adjustment knobs for positioning the positioning device.

FIGS. 4A and 4B illustrate an apparatus for forming filters including a positioning device according to a second, preferred embodiment of the present invention.

FIGS. 5A-5D illustrate detail views of the positioning device shown in FIGS. 4A and 4B.

### DESCRIPTION OF THE PREFERRED EMBODIMENTS

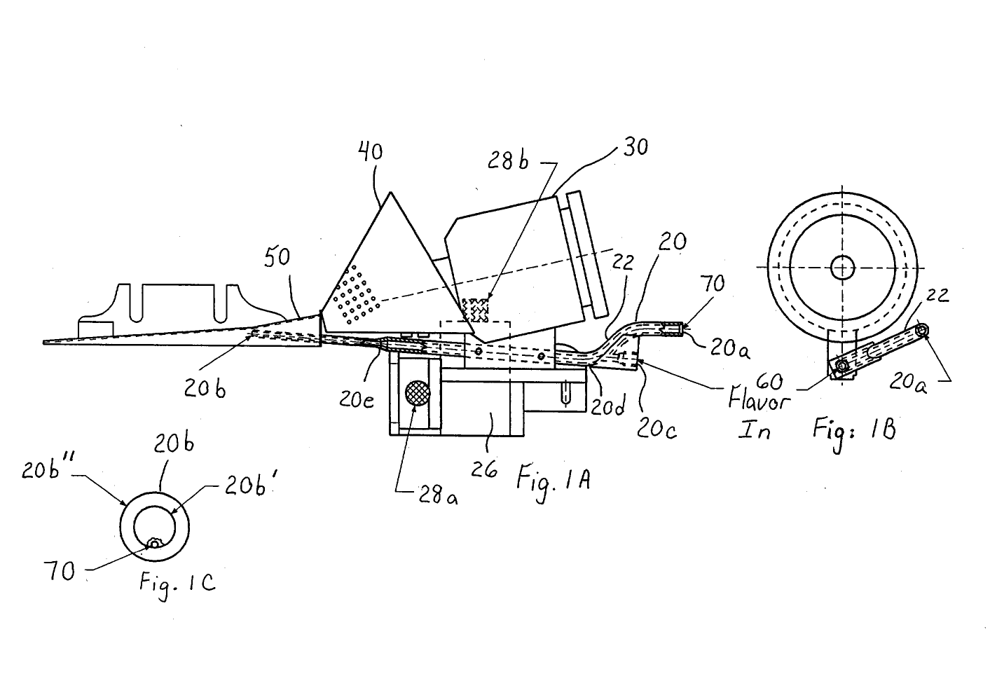

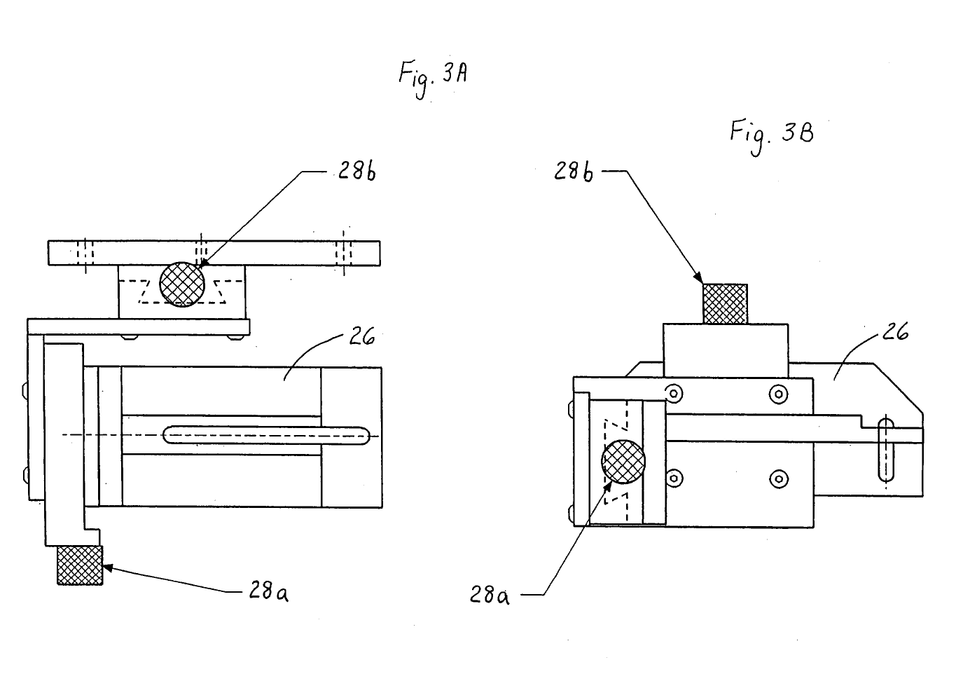

Referring initially to FIG. 1A, an embodiment of a positioning device according to the invention is combined with standard filter making equipment to provide for the positioning of a flavor element 70 that is approximately centered within a filter rod made from filter tow material. The positioning device 20 is located and adjustably positioned relative to the filter making equipment by bracket 26, horizontal adjustment knob 28a, and vertical adjustment knob 28b as shown in FIGS. 1A, 3A and 3B. The bracket 26 can hold the positioning device 20 in position relative to a transport jet 30 and an air funnel 40, with an outlet end 20b of the positioning device 20 being positioned under a tongue 50 that guides converging filter tow material exiting from the air funnel 40 into a standard garniture downstream of the outlet end 20b where the filter tow is shaped to rod form. The resulting continuous rod is then wrapped with a filter paper and the wrap is secured with a lapped and adhesively bonded seam.

Filter tow material such as cellulose acetate tow can be drawn from a bale and passed over a series of rollers (not shown) located upstream of the transport jet 30 before the filter tow material begins to be converged by the transport jet 30 and fluffed by the injection of compressed air supplied via a suitable arrangement (not shown) to the transport jet 30. After exiting the outlet end of the transport jet, the fluffed filter tow material is then further converged by the air funnel 40 before entering under the tongue 50.

The positioning device 20 is provided with a first inlet 20a, a second inlet 20c and the outlet 20b. Flavor element 70 can be introduced through the inlet 20a and guided by a first portion 22 of the positioning device 20 to a second, lower portion 20d of the positioning device 20.

The flavor element can be selected from a variety of materials including, but not limited to, cotton yarn, cellulose acetate, rayon, or other textile or non-textile materials capable of absorbing a liquid flavorant. Although a cotton yarn is particularly desirable for the practice of the present invention, the scope of the present invention also includes the use of other suitable materials capable of absorbing a liquid flavorant or other smoke enhancing substance.

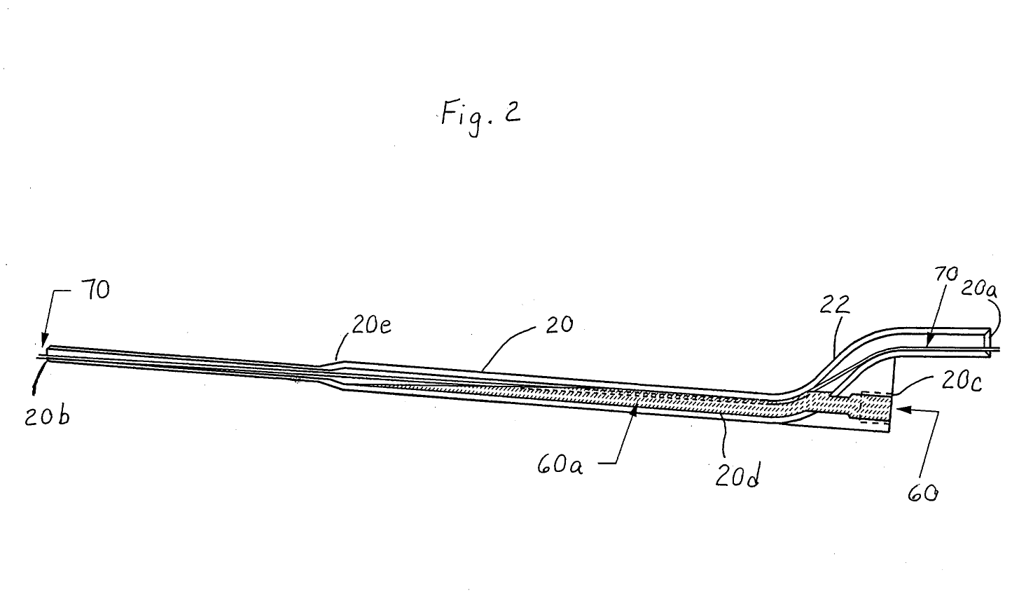

The positioning device 20 preferably comprises a non-linear tube having a passageway therethrough and a flavorant introducing attachment secured to a portion of the tube. The flavorant introducing attachment can be connected to the tube at the upstream end of the tube, or at an intermediate position downstream of where the flavor element is introduced. The positioning device 20 is preferably tilted upwards towards its outlet end 20b. In the embodiment shown in FIGS. 1A-2, liquid flavorant 60 can be introduced into the positioning device 20 through the second inlet 20c. The amount of liquid flavorant 60 introduced into the positioning device can be controlled by a metering pump (not shown). The liquid flavorant collects and forms a bath 60a at the low portion 20d of the positioning device 20. The liquid flavorant is preferably supplied at a rate which does not overflow at the inlet 20a or the outlet 20b. The positioning device 20 can be provided with changes in its internal diameter, such as at a converging portion 20e, in order to allow for a sufficient volume of liquid flavorant 60 to collect in the bath 60a at the low portion 20d, while ensuring that the outlet end 20b does not have such a large diameter 20b″ as to interfere with the converging filter tow material before it has been formed into a rod.

As shown in FIG. 1C, the outlet end 20b of the positioning device 20 is provided with a sufficiently large inside diameter 20b′ such that the continuous flavor element 70 carrying liquid flavorant 60 exits from the outlet end 20b at the desired position without creating any undesired back pressure in the positioning device. The flavor element can be provided with a diameter in the range from 0.1-3 mm, and the inside diameter of the outlet end 20b can be in the range from 0.5-30 mm, if desired. In a preferred embodiment, the continuous flavor element has a diameter of approximately 0.5 mm, while the inside diameter of the outlet end 20b is approximately 3.0 mm in diameter.

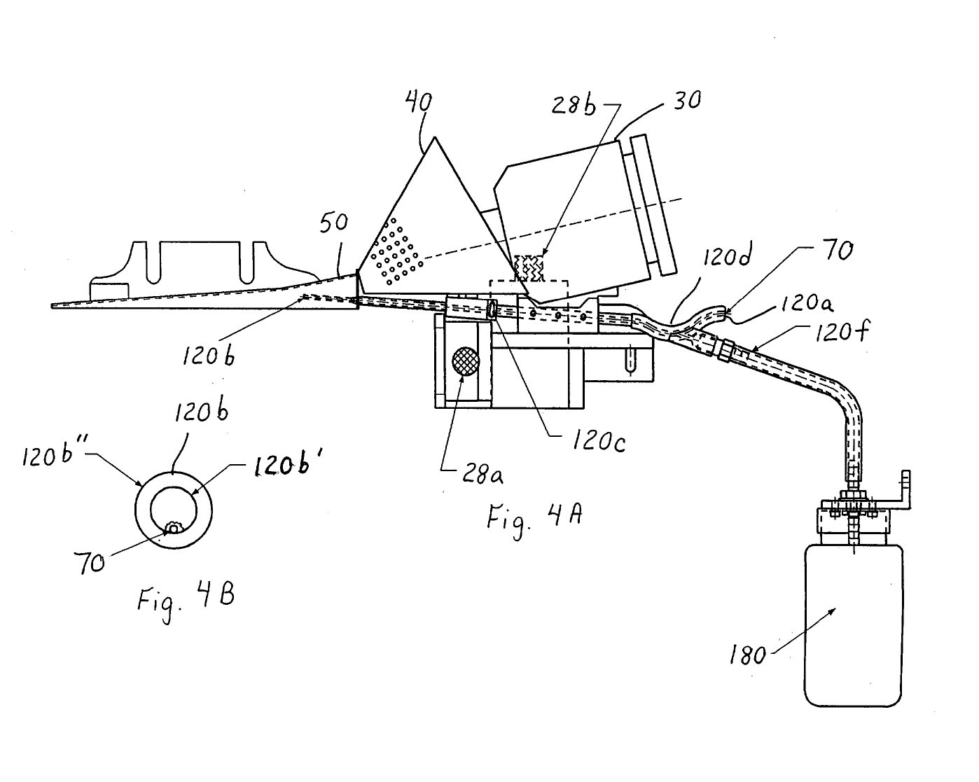

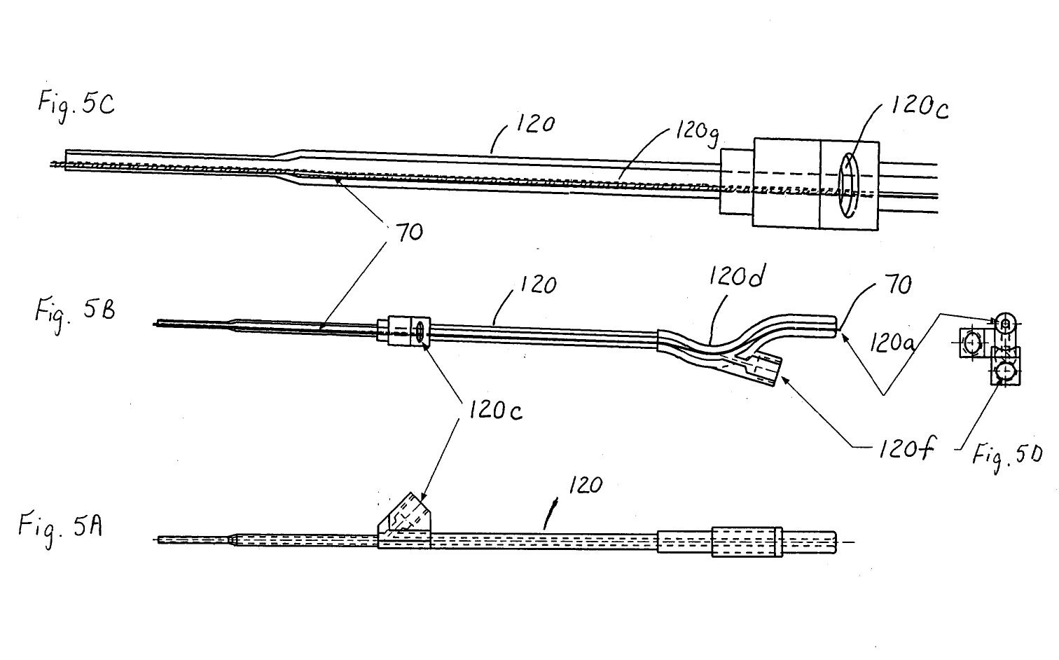

In the embodiment shown in FIGS. 4A-5C, the liquid flavorant is introduced at a downstream position from where the flavor element is introduced. As shown in FIGS. 4A and 5B, the positioning device can be configured with a “goose-neck” portion just downstream of where the flavor element 70 is introduced. This configuration ensures that the flavor element travels along the bottom of the positioning device to the exit. Referring to FIGS. 4A-5D, the illustrated embodiment of the positioning device 120 has an inlet 120a for passage of the flavor element 70, a bent or “goose-neck” portion 120d with an attached drain 120f, a downstream inlet 120c for introduction of liquid flavorant 60, and an outlet 120b. The continuous flavor element is introduced through inlet 120a, and is guided by the goose-neck portion 120d so that the flavor element then follows the bottom of the positioning device 120 all the way to the outlet 120b, as best seen in FIGS. 5B and 5C. The liquid flavorant 60 is introduced into the positioning device 120 through downstream inlet 120c at a rate such that, when equilibrium is reached, the flavor element traveling along the bottom of the passageway through the positioning device partially absorbs and carries all of the flavorant introduced through inlet 120c with the flavor element exiting from outlet 120b into the path of converging filter tow material. A drain 120f can be provided at the end of the device 120 adjacent flavor element inlet 120a. Because the device 120 is angled upwards toward outlet 120b, the drain 120f at the end of device 120 opposite from the outlet end 120b is at the lowest point, and provides a means for draining any excess flavorant not carried out of the device 120 by the flavor element. A collecting receptacle 180 can be provided at the end of drain 120f to avoid evaporative loss of the excess flavorant.

The filter tow material that is converging through air funnel 40 and underneath the tongue 50 completely surrounds the outlet end 20b of the positioning device 20 in the embodiment of FIG. 1A and the outlet end 120b of device 120 in FIG. 4A. As the filter tow material continues downstream past the outlet end 20b, 120b, the tow material pulls along with it the flavor element 70 exiting from the outlet end 20b, 120b. Bracket 26 and adjustment knobs 28a, 28b, best seen in FIGS. 3A and 3B, supporting the positioning device 20, 120 allow for accurate positioning of the outlet end 20b, 120b relative to the converging filter tow material.

As best seen in the end view of FIG. 1B, the inlet end portion 22 of the positioning device 20 used with the embodiment shown in FIGS. 1A-1C can be rotated to a desired angle from vertical in order to achieve the desired clearance between the positioning device 20 and the filter making equipment including transport jet 30 and air funnel 40, or to achieve clearance with the filter material passing into the transport jet. The elevation at the second inlet 20c of this embodiment can also be chosen such that liquid flavorant introduced through the inlet 20c collects in a bath at the low portion 20d, without being urged out of the outlet end 20b by an elevation head.

The bracket 26 supporting positioning device 20 can be integrally formed with transport jet 30 and air funnel 40, or it can be otherwise connected thereto using conventional joining techniques. In the embodiment of FIG. 1A, the orientation of the positioning device 20, as controlled by bracket 26 and positioning knobs 28a, 28b, ensures that a desired amount of liquid flavorant introduced through inlet 20c collects in the low portion 20d of the positioning device to form a bath 60a of the liquid flavorant. The continuous flavor element 70 introduced through inlet 20a is then guided into the bath 60a by inlet portion 22 of the positioning device 20 such that the liquid flavorant 60 is either partially absorbed by the flavor element 70 and/or clings to it by surface tension as the flavor element 70 exits from the outlet end 20b of the positioning device 20. If desired, the positioning device can be provided in other arrangements wherein the passageway includes the bath along the length thereof, or the flavor element removes all liquid flavorant as it is introduced to the device, such that no bath is formed, such as in the embodiment of FIG. 4A.

After the continuous flavor element is partially saturated with liquid flavorant by passing through the bath collected at the low portion 20d, or by passing through flavorant being introduced to the positioning device, it is entrained by the converging filter tow downstream from the outlet end 20b, 120b and incorporated into a continuous rod by the tongue 50. The continuous filter rod can then be cut into desired lengths to form filters or filter segments that each have the flavor element positioned at approximately the center, or any other desired position in the filter rod.

Although embodiments of a filter making apparatus including the positioning device according to the present invention are shown in the figures, the invention is not limited to the described embodiments, and can encompass other arrangements within the scope of the attached claims. The positioning device can be used with filter making apparatus having other arrangements for converging filter tow material into rod form. The positioning device provides for accurate positioning of a flavor element within a filter or filter segment that is formed from filter tow material. As the filter tow material is converged into a finished filter rod, the filter tow material pulls the continuous flavor element carrying liquid flavorant along with it such that the flavor element is positioned in approximately the center of the finished rod. Alternatively, the positioning device can be used to position the continuous flavor element at a different desired position within the finished filter rod. The dimensions and orientation of the positioning device can be modified to provide the bath in arrangements other than the tubular arrangement described above.

What is claimed is:

1. A filter making apparatus, comprising:
a filter tow converging device;
a flavor element positioning device having a passageway with a first inlet, a second inlet, and an outlet, at least one of the first and second inlets being in fluid communication with the passageway, the outlet being positioned at a point downstream from at least a portion of the filter tow converging device;
a first portion of said positioning device adapted to collect some flavorant passing through said passageway into a bath of flavorant upstream of said outlet.

2. The filter making apparatus according to claim 1, wherein:
a second portion of said positioning device directs a flavor element introduced through said first inlet into said bath, said flavor element passing from said bath out through said outlet.

3. The filter making apparatus according to claim 1, wherein:
the positioning device is tilted upward toward the outlet such that said first portion is a low portion of the device.

4. The filter making apparatus according to claim 3, wherein:
the outlet has an internal diameter sufficiently large to allow passage of the flavor element without creating undesirable back pressure in the flavorant.

5. The filter making apparatus according to claim 1, wherein:
said filter tow converging device comprises a transport jet and an air funnel.

6. The filter making apparatus according to claim 1, wherein:
said flavor element positioning device is mounted adjustably on said filter tow converging device.

7. The filter making apparatus according to claim 6, wherein:
said filter tow converging device comprises a transport jet and an air funnel.

8. The filter making apparatus according to claim 1, wherein:
at least one of said inlets is open to atmospheric pressure.

9. The filter making apparatus according to claim 1, wherein:
said flavor element positioning device is formed from a bent tube.

10. The filter making apparatus according to claim 9, wherein:
said bent tube defines a converging passageway therethrough.

11. A filter making apparatus, comprising:
a positioning device having a passageway therethrough, said passageway guiding a continuous strand of material from an inlet of said passageway to an outlet of said passageway;
a portion of said passageway forming a bath of a liquid flavorant supplied to said passageway through another inlet at approximately atmospheric pressure; and
the outlet of said passageway being positioned in the path of filter tow material at a point downstream of at least a portion of a converging device that funnels the filter tow material, and at a point upstream of where the filter material is formed into a cylindrical rod.

12. A method of producing a filter, comprising:
advancing a supply of filter material;
converging the advancing filter material to a rod form;
passing a continuous strand of material through a positioning device that entrains the strand with the advancing filter material at a point upstream of where the filter tow material is formed into a rod;
forming a bath of liquid flavorant in at least a portion of the positioning device; and
directing the strand through the bath with another portion of the positioning device.

13. A method of producing a filter using the filter making apparatus according to claim 1, comprising:
advancing a supply of filter tow material;
funneling the advancing filter tow material to a rod form;
passing a continuous strand of material through the positioning device to entrain the strand of material with the advancing filter tow material;
supplying a liquid flavorant at approximately atmospheric pressure to the positioning device and at a predetermined flow rate; and
passing the strand of material through the liquid flavorant before being entrained in the advancing filter tow material, with the strand of material carrying the supplied liquid flavorant out of the positioning device at a rate substantially equal to the predetermined flow rate.

14. The method according to claim 13, further including:
adjusting the position of the outlet of the positioning device relative to the advancing filter tow material by manipulating an adjustment device on a bracket supporting the positioning device relative to the filter tow converging device.

15. The method according to claim 14, further including:
converging the advancing filter tow material having the continuous strand of material entrained therein to form a continuous filter rod.

16. The method according to claim 15, further including:
wrapping the continuous filter rod in a paper material and cutting the filter rod into segments of desired length.

17. A filter making apparatus, comprising a flavor element positioning device having a passageway with a first inlet, a second inlet, and an outlet, said second inlet being in fluid communication with said passageway and positioned downstream of said first inlet, and
a first portion of said positioning device forming a curved portion adapted to guide a flavor element passing through said positioning device to a position along the bottom of said positioning device downstream of said curved portion.

18. The filter making apparatus according to claim 17, wherein the outlet of said passageway is adapted to be positioned in the path of filter tow material at a point downstream of at least a portion of a converging device that funnels the filter material, and at a point upstream of where the filter material has formed a rod.

19. The filter making apparatus according to claim 18, further including a drain outlet at the end of said positioning device opposite from said outlet.

20. The filter making apparatus according to claim 19, wherein said passageway has a variable cross-section.

21. The filter making apparatus according to claim 20, further including a supporting bracket that adjustably positions said outlet of said positioning device relative to the path of filter tow material.
